(19) United States
(12) Patent Application Publication
(10) Pub. No.: US 2009/0169281 A1
(43) Pub. Date: Jul. 2, 2009

(54) Image forming apparatus

(75) Inventor: Takeshi Oyama, Tokyo (JP)

Correspondence Address: KUBOTERA & ASSOCIATES, LLC, Suite 202, 200 Daingerfield Road, Alexandria, VA, 22314, US

(73) Assignee: Oki Data Corporation

(21) Appl. No.: 12/318,381

(22) Filed: Dec. 29, 2008

(30) Foreign Application Priority Data
Dec. 27, 2007 (JP) 2007-337481

(51) Int. Cl. G03G 15/00

(52) U.S. Cl. 399/405

(57) ABSTRACT

An image forming apparatus includes a first image processing unit for performing a first image processing; a discharge unit disposed above the first image processing unit for discharging a medium after the first image processing is performed on the medium; a medium placing unit for placing the medium thus discharged; a second image processing unit disposed above the medium placing unit for performing a second image processing; and an operational unit disposed on the second image processing unit at a specific position thereof for performing a specific operation. The medium placing unit may include a step portion for forming a space between the medium thus discharged and a surface of the medium placing unit. The step portion and the operational unit may be situated at positions, so that the operational unit does not block the step portion viewed from above the image forming apparatus.

### BACKGROUND OF THE INVENTION AND RELATED ART STATEMENT

The present invention relates to an image forming apparatus.

In a conventional image forming apparatus such as a printer, a copier, a facsimile, and a multi-function product, a printer unit is disposed on a base portion, and a scanner unit is placed on a placing table disposed to freely move relative to the base portion in a vertical direction.

In the conventional image forming apparatus, the placing table is selectively situated at two positions for placing the scanner unit. That is, the placing table is selectively situated at a position for a normal use, and another position for not interfering with a top cover of the printer unit when the top cover is opened (refer to Patent Reference).

### Patent Reference: Japanese Patent Publication No. 2006-091429

In the conventional image forming apparatus described above, the placing table for placing the scanner unit excessively protrudes in a direction that a sheet as a medium is taken out from the conventional image forming apparatus. Accordingly, it is difficult to take out the sheet after being discharged, especially a sheet having a small length. Further, it is necessary to take out the sheet after the placing table is lifted, thereby making it further difficult to take out the sheet.

In view of the problems described above, an object of the present invention is to provide an image forming apparatus capable of solving the problems of the conventional image forming apparatus, in which it is possible to easily take out a medium.

Further objects and advantages of the invention will be apparent from the following description of the invention.

### SUMMARY OF THE INVENTION

In order to attain the objects described above, according to the present invention, an image forming apparatus includes a first image processing unit for performing a first image processing; a discharge unit disposed above the first image processing unit for discharging a medium after the first image processing is performed on the medium; a medium placing unit for placing the medium thus discharged; a second image processing unit disposed above the medium placing unit for performing a second image processing; and an operational unit disposed on the second image processing unit at a specific position thereof for performing a specific operation.

According to the present invention, the medium placing unit may include a step portion for forming a space between the medium thus discharged and a surface of the medium placing unit. The step portion and the operational unit may be situated at positions, so that the operational unit does not block the step portion viewed from above the image forming apparatus.

In the present invention, as described above, the image forming apparatus includes the first image processing unit for performing the first image processing; the discharge unit disposed above the first image processing unit for discharging the medium after the first image processing is performed on the medium; the medium placing unit for placing the medium thus discharged; the second image processing unit disposed above the medium placing unit for performing the second image processing; and the operational unit disposed on the second image processing unit at the specific position thereof for performing the specific operation.

Further, the medium placing unit may include the step portion for forming the space between the medium thus discharged and the surface of the medium placing unit. The step portion and the operational unit may be situated at the positions, so that the operational unit does not block the step portion viewed from above the image forming apparatus.

Accordingly, it is possible for an operator to see the step portion from above the image forming apparatus. As a result, it is possible to easily take out the medium placed in the medium placing unit, thereby improving handling of the medium.

### BRIEF DESCRIPTION OF THE DRAWINGS

FIG. 1 is a perspective view showing a sheet placing unit of a multi-function product according to a first embodiment of the present invention;

FIG. 2 is a front view showing the multi-function product according to the-first embodiment of the present invention;

FIG. 3 is a side view showing the multi-function product according to the first embodiment of the present invention;

FIG. 4 is a plan view showing the multi-function product according to the first embodiment of the present invention;

FIG. 5 is a schematic view showing a transportation path of a sheet of the multi-function product according to the first embodiment of the present invention;

FIG. 6 is a flow chart showing an operation of the multi-function product according to the first embodiment of the present invention;

FIG. 7 is a plan view showing the sheet placing unit of the multi-function product according to the first embodiment of the present invention;

FIG. 8 is a schematic view showing the sheet placing unit of the multi-function product in a state that the sheet is placed on the sheet placing unit according to the first embodiment of the present invention;

FIG. 9 is a perspective view showing a modified example of the sheet placing unit of the multi-function product according to the first embodiment of the present invention;

FIG. 10 is a perspective view showing a sheet placing unit of a multi-function product according to a second embodiment of the present invention;

FIG. 11 is a schematic view No. 1 showing the sheet placing unit of the multi-function product in a state that the sheet is placed on the sheet placing unit according to the second embodiment of the present invention;

FIG. 12 is a schematic view No. 2 showing the sheet placing unit of the multi-function product in the state that the sheet is placed on the sheet placing unit according to the second embodiment of the present invention;

FIG. 13 is a schematic view No. 3 showing the sheet placing unit of the multi-function product in the state that the sheet is placed on the sheet placing unit according to the second embodiment of the present invention;

FIG. 14 is a perspective view showing a multi-function product according to a third embodiment of the present invention; and

FIG. 15 is a side view showing the multi-function product according to the third embodiment of the present invention.

### DETAILED DESCRIPTION OF THE PREFERRED EMBODIMENTS

Hereunder, embodiments of the present invention will be explained with reference to the accompanying drawings. In the drawings, similar components are designated with the same reference numerals. In the following description, a multi-function product will be explained as an image forming apparatus.

### First Embodiment

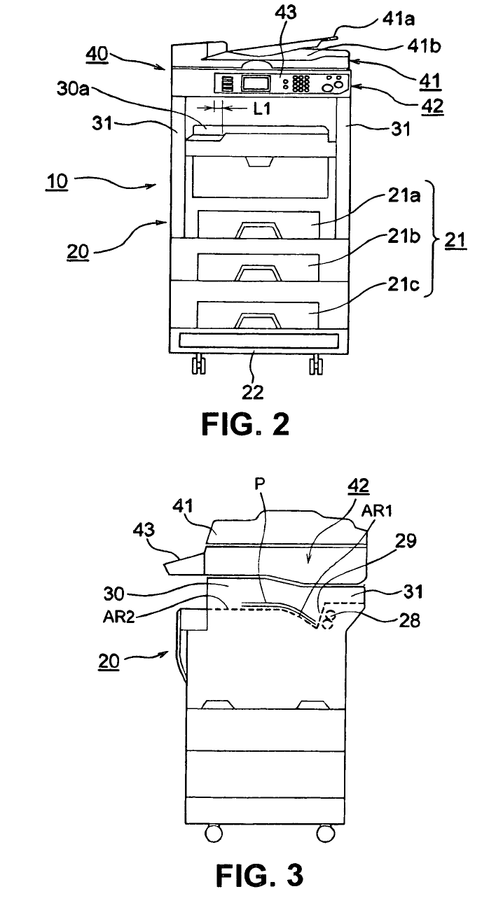

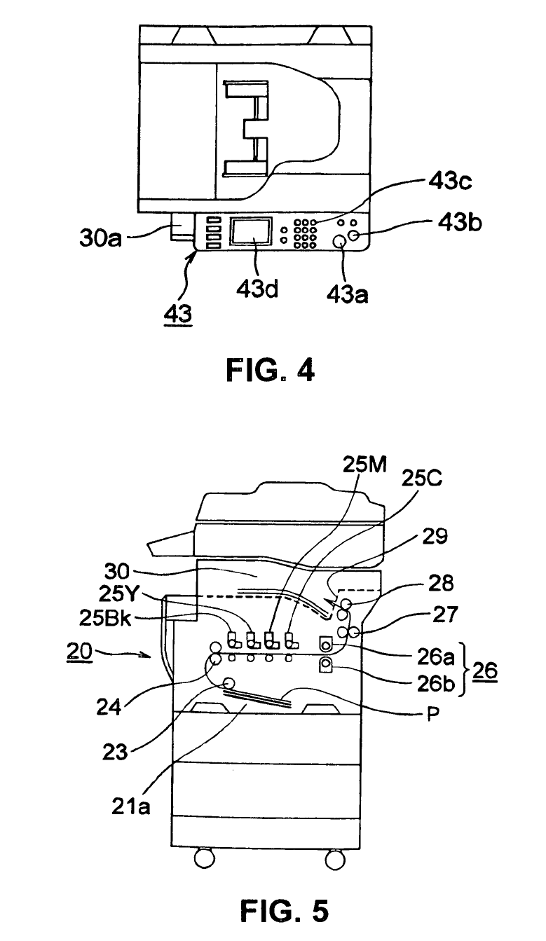

A first embodiment of the present invention will be explained. FIG. 2 is a front view showing a multi-function product 10 according to the first embodiment of the present invention. FIG. 3 is a side view showing the multi-function product 10 according to the first embodiment of the present invention. FIG. 4 is a plan view showing the multi-function product 10 according to the first embodiment of the present invention. FIG. 5 is a schematic view showing a transportation path of a sheet of the multi-function product 10 according to the first embodiment of the present invention.

As shown in FIG. 2, the multi-function product 10 includes a printer unit 20 as an image forming unit for forming an image (printing) on a sheet P as a first medium; a scanner unit 40 as an image reading unit disposed above the printer unit 20 for reading an image on an original as a second medium; and an operational unit 43 for performing a specific operation of the multi-function product 10.

In the embodiment, the printer unit 20 constitutes a first image processing unit for forming an image through a first image processing and a second image processing unit for reading an image through a second image processing.

In the embodiment, the printer unit 20 includes a sheet supply unit 21 at a lower portion thereof. The sheet supply unit 21 includes a sheet supply tray 21a as a default tray or a first medium storage unit at an uppermost stage; and sheet supply trays 21b and 21c as optional trays or second sheet storage units at second and third stages, respectively. Further, the printer unit 20 includes a cabinet 22 as a storage member for storing the sheet at a lowermost stage.

In the embodiment, when a sheet supply roller 23 (refer to FIG. 5) rotates, the sheet P stored in one of the sheet trays 21a, 21b, or 21c is transported to the transportation path one by one. Then, a transport roller 24 disposed in the transportation path transports the sheet P to image forming units 25Bk, 25Y, 25M, and 25C for forming images in black, yellow, magenta, and cyan, respectively. Each of the image forming units 25Bk, 25Y, 25M, and 25C includes a photosensitive drum (not shown) as an image supporting member, and a transfer roller as a transfer member disposed to face the photosensitive drum for transferring a toner image as a developer image to the sheet P.

In the embodiment, the image forming units 25Bk, 25Y, 25M, and 25C form static latent images as latent images on the photosensitive drums, and develop the static latent images with toner as developer to from the toner images.

In the embodiment, a fixing device 26 is disposed on a downstream side of the image forming units 25Bk, 25Y, 25M, and 25C for fixing the toner images transferred to the sheet P to the sheet P. The fixing device 26 includes a heating roller 26a as a first roller and a pressing roller 26b as a second roller. A heater (not shown) as a heating member is disposed in the heating roller 26a.

When the sheet P is transported to the fixing device 26, the fixing device 26 heats and presses the toner images to fix the toner images to the sheet P. Afterward, a transport roller 27 transports the sheet P, and a discharge roller 28 discharges the sheet P to a sheet placing unit 30 as a medium placing unit through a discharge outlet 29 as a discharge portion. A recess portion 30a is formed in the sheet placing unit 30 at a specific position thereof.

In the embodiment, the sheet placing unit 30 is disposed between an upper surface of the printer unit 20 and a bottom surface of the scanner unit 40. Sidewalls 31 connecting the printer unit 20 and the scanner unit 40 surround both sides of the sheet placing unit 30. Further, the sheet placing unit 30 includes an inclined portion AR1 inclined from a middle portion thereof toward an upstream side thereof in a discharge direction, and a flat portion AR2 situated from the middle portion to a downstream side thereof. Accordingly, the sheet placing unit 30 is formed in a curved shape curved downwardly toward the discharge outlet 29 for aligning an trailing edge of the sheet P.

In the embodiment, the scanner unit 40 includes an automatic document feeding unit (ADF) 41 and a flat bed 42 having a surface covered with a glass. The ADF 41 includes an original placing table 41a and an original discharge portion 41b. The operational unit 43 is disposed on the scanner unit 40 at a specific position thereof, i.e., on the flat bed 42 at a frond side of the multi-function product 10. The recess portion 30a is formed such that a distance L1 between a left edge of the operational unit 43 and a right edge of the recess portion 30a becomes about 20 mm (refer to FIG. 2).

In the embodiment, a roller (not shown) transports an original placed on the original placing table 41a to the flat bed 42 one by one according to an instruction from the operational unit 43. An image on the original is read at the operational unit 43, and then the original is discharged on the original discharge portion 41b.

As shown in FIG. 4, the operational unit 43 includes operation elements such as a start key 43a; a stop key 43b; a ten-key 43c; a touch panel 43d; and the likes. An operator operates each of the operation elements for sending an instruction to the printer unit 20 and the scanner unit 40.

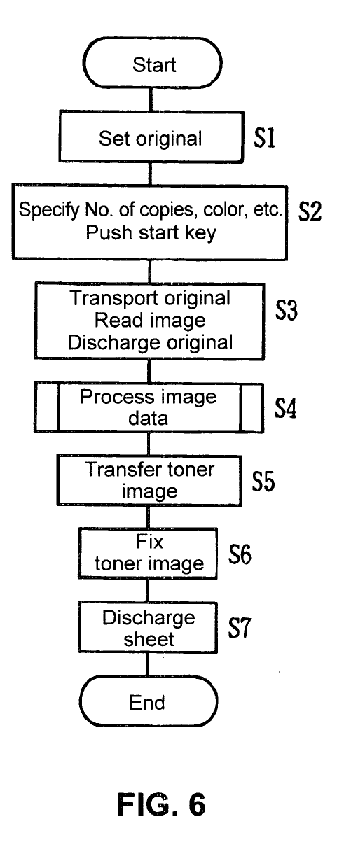

An operation of the multi-function product 10 will be explained next. FIG. 6 is a flow chart showing the operation of the multi-function product 10 according to the first embodiment of the present invention. In the operation, the ADF 41 is used.

First, the operator places the original to be copied on the original placing table 41a. Then, the operator operates the ten-key 43a and the touch panel 43d of the ADF 41 to specify a number of copies, color (black or color), and the likes. When the operator pushes the start key 43a, the roller (not shown) transports the original placed on the original placing table 41a to the flat bed 42 one by one, so that the original is read on the flat bed 42. Afterward, the original is discharged to the original discharge portion 41b.

In the next step, data of the image thud read are sent as image data to a control unit (not shown), and an image processing section of the control unit processes the image data, thereby sending the image data to the printer unit 20.

When the printer unit 20 receives the image data, the printer unit 20 starts a printing operation. When the sheet supply roller 23 (refer to FIG. 5) rotates, the sheet P stored in one of the sheet trays 21a, 21b, or 21c is transported to the transportation path one by one. Then, the transport roller 24 disposed in the transportation path transports the sheet P to the image forming units 25Bk, 25Y, 25M, and 25C.

At this time, the image forming units 25Bk, 25Y, 25M, and 25C form the static latent images on the photosensitive drums, and develop the static latent images with toner to from the toner images. The transfer rollers transfer the toner images to the sheet P.

In the next step, when the sheet P is transported to the fixing device 26, the fixing device 26 fixes the toner images to the sheet P. Afterward, the transport roller 27 disposed in the transportation path transports the sheet P. and the discharge roller 28 discharges the sheet P to the sheet placing unit 30.

The flow chart shown in FIG. 6 will be explained. In step S1, the operator sets the original. In step S2, the operator specifies a number of copies, color, and the likes, and pushes the start key 43a. In step S3, the original is transported, the image is read, and the original is discharged.

In step S4, the image data are processed. In step S5, the toner images are transferred to the sheet P. In step S6, the toner images are fixed. In step S7, the sheet P is discharged, and the process is completed.

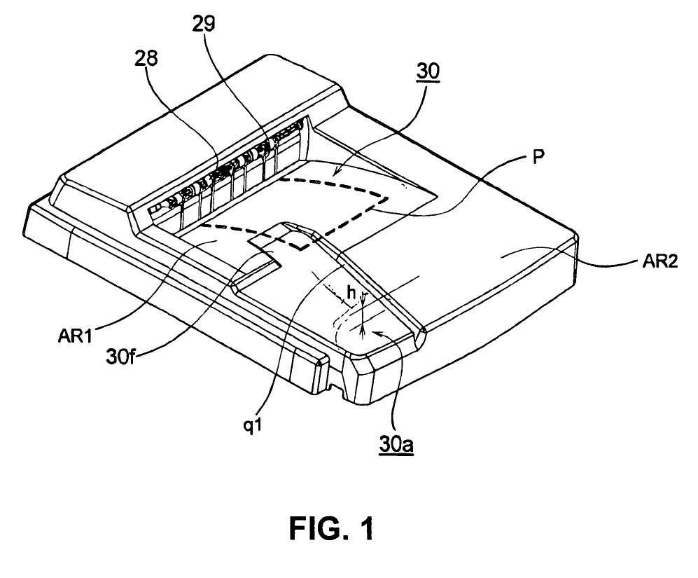

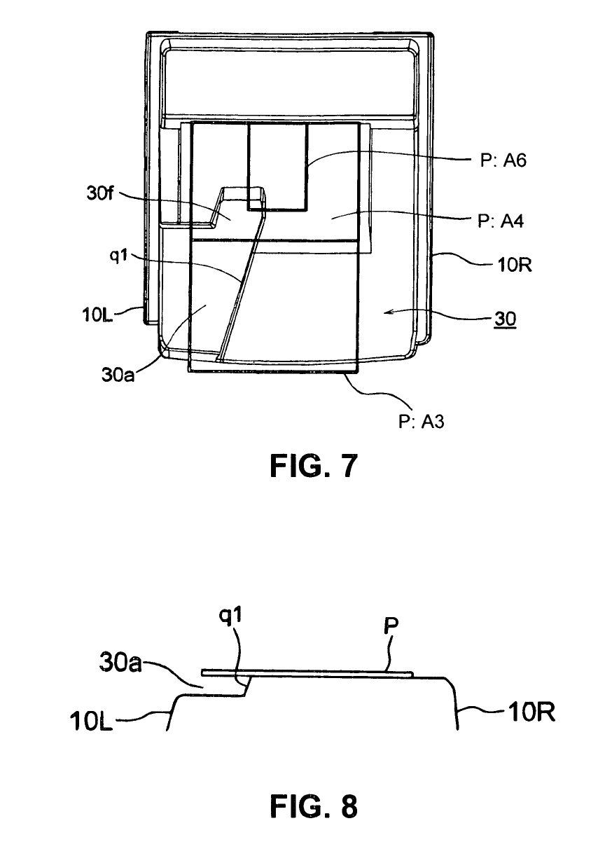

A configuration of the sheet placing unit 30 will be explained next. FIG. 1 is a perspective view showing the sheet placing unit 30 of the multi-function product 10 according to a first embodiment of the present invention. FIG. 7 is a plan view showing the sheet placing unit 30 of the multi-function product 10 according to the first embodiment of the present invention. FIG. 8 is a schematic view showing the sheet placing unit 30 of the multi-function product 10 in a state that the sheet P is placed on the sheet placing unit 30 according to the first embodiment of the present invention.

As shown in FIG. 1, the sheet placing unit 30 is formed in the curved shape curved downwardly toward the discharge outlet 29 for aligning an trailing edge of the sheet P. The recess portion 30a is formed in an upper surface of the sheet placing unit 30, so that a step portion q1 is formed between the recess portion 30a and the upper surface of the sheet placing unit 30. The step portion q1 forms a space at the flat portion AR2 for accommodating a finger of the operator between the sheet P and the recess portion 30a. The step portion q1 has a height h of about 15 mm, and the height h decreases in the inclined portion AR1 toward the discharge outlet 29.

As shown in FIGS. 7 and 8, the recess portion 30a is formed at a position corresponding to a specific position of the sheet P with various sizes. More specifically, the recess portion 30a is formed at a position on a side of a first side surface 10L of the multi-function product 10 or a left side of the multi-function product 10 viewed from the front side of the multi-function product 10.

In the embodiment, the recess portion 30a is formed in a shape gradually widening from a left edge (toward the discharge outlet 29) of the multi-function product 10 on the front side (a side of the operational unit 43) thereof to a rear side (a side of the discharge outlet 29) thereof. Accordingly, an edge of the recess portion 30a and the step portion q1 formed at the edge extend obliquely toward a center side from the front side to the rear side of the multi-function product 10. Further, the recess portion 30a is formed such that the distance L1 between the left edge of the operational unit 43 and the right edge of the recess portion 30a becomes about 20 mm (refer to FIG. 2). Further, an extending portion 30f with a rectangular shape is formed at a right rear side of the recess portion 30a.

As shown in FIGS. 2 and 4, the recess portion 30a is disposed toward the left side of the multi-function product 10 viewed from the front side of the multi-function product 10. Further, the operational unit 43 is disposed toward the right side of the multi-function product 10 viewed from the front side of the multi-function product 10, that is, a side of a second side surface 10R of the multi-function product 10 above the sheet placing unit 30. Accordingly, the recess portion 30a becomes visible from above the multi-function product 10 at the side of the first side surface 10L, thereby making it easy to confirm whether the sheet P is discharged, or take out the sheet P.

In general, the sheet P may have various widths and lengths, and has a standard size for a normal use. The standard size is registered in the multi-function product 10 in advance with a printer driver and the likes of a personal computer as a host device, and may includes an A4 size, an A3 size, a B5 size, a letter size, and the likes. It is assumed that the multi-function product 10 can handle the sheet P having an A6 size (longitudinal transportation) at minimum or the A3 size (longitudinal transportation) at maximum.

As shown in FIG. 7, when the sheet P having the A6 size or the A3 size is placed on the sheet placing unit 30, an edge and a left front corner of the sheet P viewed from the front side of the multi-function product 10 are situated in the recess portion 30a. Accordingly, it is possible to securely pick up the left front corner of the sheet P in the recess portion 30a with a finger. It is preferred that the step portion q1 is formed such that an edge or a corner of the sheet P having the A4 size or the letter size, i.e., sizes more frequently used, is situated in the recess portion 30a.

As described above, in the embodiment, the recess portion 30a is disposed toward the side of the first side surface 10L of the multi-function product 10 viewed from the front side of the multi-function product 10. Further, the operational unit 43 is disposed toward the side of the second side surface 10R of the multi-function product 10 viewed from the front side of the multi-function product 10. Accordingly, the operational unit 43 does not block the recess portion 30a and the step portion q1, or a lower surface of the sheet placing unit 30 below the step portion q1, or a space between the sheet placing unit 30 and the sheet P, viewed from above the multi-function product 10, and the recess portion 30a and the step portion q1 become visible from above the multi-function product 10. Accordingly, it is possible for the operator to easily take out the sheet P discharged on the sheet placing unit 30, thereby improving handling ability of the sheet P.

In the embodiment, the corner or the edge of the sheet P is situated in the recess portion 30a. Further, the space is formed between the corner or the edge of the sheet P and the recess portion 30a in the sheet placing unit 30. Accordingly, it is possible to further improve handling ability of the sheet P.

In the embodiment, the recess portion 30a has the width gradually increasing toward the rear side of the multi-function product 10 (the side of the discharge outlet 29). Accordingly, the sheet P on the sheet placing unit 30 is supported with a large area, thereby preventing the sheet P from hanging down in the recess portion 30a to a large extent.

In the embodiment, the recess portion 30a is disposed toward the left side of the multi-function product 10 at the front side thereof, and the operational unit 43 is disposed toward the right side of the multi-function product 10 at the front side thereof. Alternatively, the recess portion 30a may be disposed toward the right side of the multi-function product 10 at the front side thereof, and the operational unit 43 may be disposed toward the left side of the multi-function product 10 at the front side thereof.

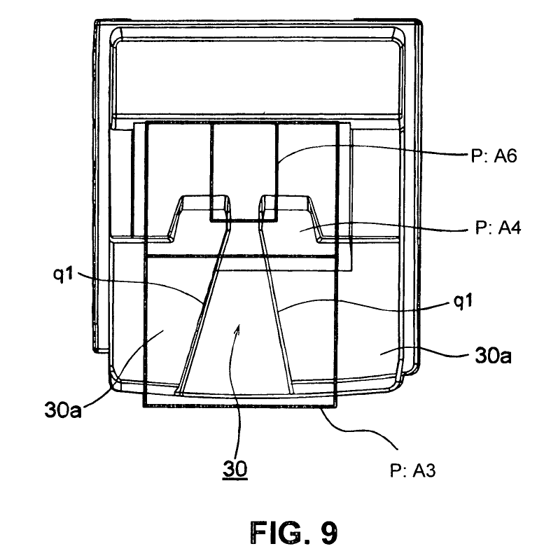

A modified example of the sheet placing unit 30 will be explained next. FIG. 9 is a perspective view showing the modified example of the sheet placing unit 30 of the multi-function product 10 according to the first embodiment of the present invention.

As shown in FIG. 9, the operational unit 43 has a reduced size, and is disposed at a center position on the front side of the multi-function product 10. The recess portions 30a are formed at both edges of the multi-function product 10 on the front side thereof.

### Second Embodiment

A second embodiment of the present invention will be explained. Components in the second embodiment similar to those in the first embodiment are designated by the same reference numerals, and explanations thereof are omitted. The components in the second embodiment similar to those in the first embodiment provide effects same as those in the first embodiment, and explanations thereof are omitted.

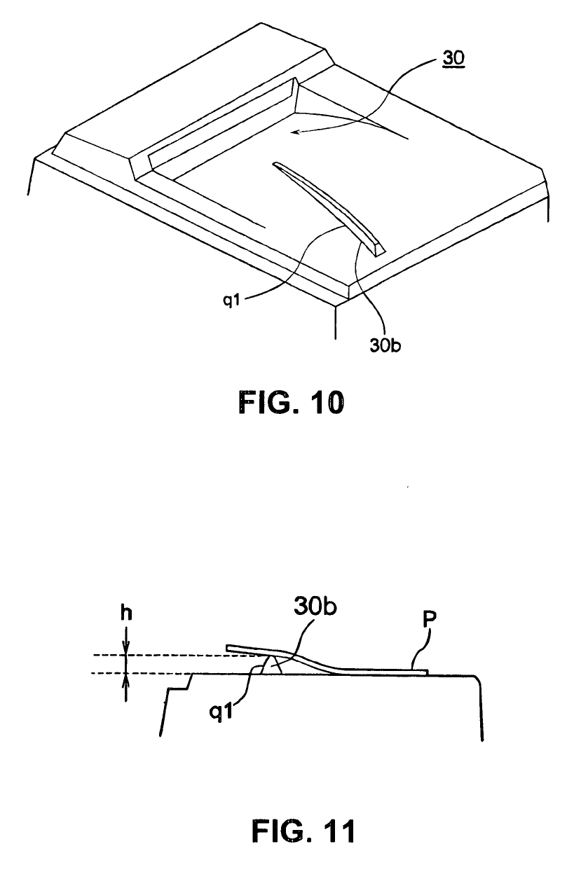

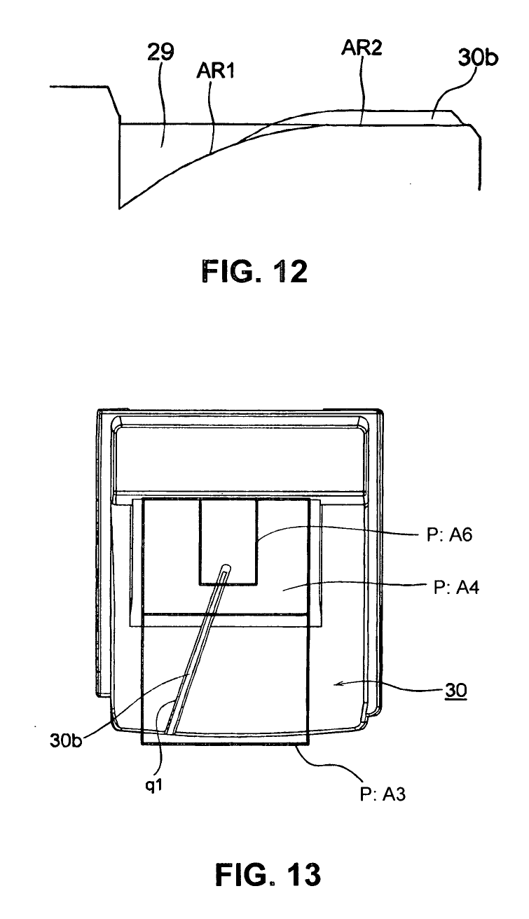

FIG. 10 is a perspective view showing the sheet placing unit 30 of the multi-function product 10 according to the second embodiment of the present invention. FIG. 11 is a schematic view No. 1 showing the sheet placing unit 30 of the multi-function product 10 in a state that the sheet P is placed on the sheet placing unit 30 according to the second embodiment of the present invention. FIG. 12 is a schematic view No. 2 showing the sheet placing unit 30 of the multi-function product 10 in the state that the sheet P is placed on the sheet placing unit 30 according to the second embodiment of the present invention. FIG. 13 is a schematic view No. 3 showing the sheet placing unit 30 of the multi-function product 10 in the state that the sheet P is placed on the sheet placing unit 30 according to the second embodiment of the present invention.

As shown in FIGS. 10 to 13, instead of the recess portion 30a in the first embodiment, a protruded portion 30b with a band shape is formed on the sheet placing unit 30, so that the step portion q1 is formed between the protruded portion 30b and the sheet placing unit 30. The step portion q1 forms a space at the flat portion AR2 for accommodating the finger of the operator between the sheet P and the sheet placing unit 30. Further, the step portion q1 has a height h of about 15 mm, and the height h decreases in the inclined portion AR1 toward the discharge outlet 29.

In the embodiment, the protruded portion 30b is formed to extend from the left edge (toward the discharge outlet 29) of the multi-function product 10 on the front side (the side of the operational unit 43) thereof to the rear side (the side of the discharge outlet 29) thereof toward the center side thereof.

As described above, the protruded portion 30b is formed to extend from the left edge to the rear right side of the multi-function product 10. Further, the operational unit 43 is disposed toward the right side of the multi-function product 10 at the front side thereof above the sheet placing unit 30. Accordingly, it is possible to easily see the protruded portion 30b from above, thereby making it easy to confirm whether the sheet P is discharged, or take out the sheet P.

In the embodiment, the protruded portion 30b is disposed toward the left side of the multi-function product 10 at the front side thereof, and the operational unit 43 is disposed toward the right side of the multi-function product 10 at the front side thereof. Alternatively, the protruded portion 30b may be disposed toward the right side of the multi-function product 10 at the front side thereof, and the operational unit 43 may be disposed toward the left side of the multi-function product 10 at the front side thereof.

Further, the operational unit 43 may have a reduced size, and is disposed at the center position on the front side of the multi-function product 10. In this case, the protruded portions 30b may be formed at the both edges of the multi-function product 10 on the front side thereof.

### Third Embodiment

A third embodiment of the present invention will be explained. Components in the third embodiment similar to those in the first and second embodiments are designated by the same reference numerals, and explanations thereof are omitted. The components in the third embodiment similar to those in the first and second embodiments provide effects same as those in the first embodiment, and explanations thereof are omitted.

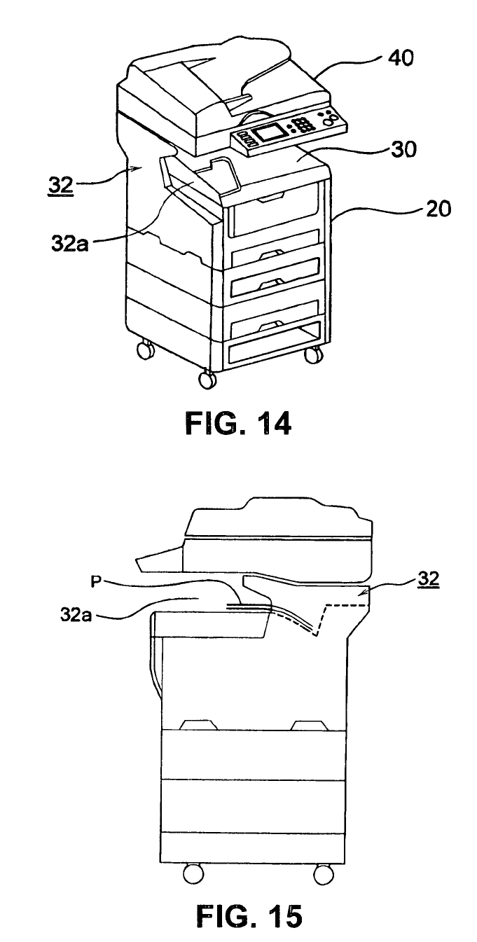

FIG. 14 is a perspective view showing the multi-function product 10 according to the third embodiment of the present invention. FIG. 15 is a side view showing the multi-function product 10 according to the third embodiment of the present invention.

As shown in FIGS. 14 and 15, the sheet placing unit 30 is disposed between the printer unit 20 and the scanner unit 40, and sidewall portions 32 are disposed on left and right sides of the multi-function product 10 for connecting the printer unit 20 and the scanner unit 40.

In the embodiment, each of the sidewall portions 32 includes a cut portion 32a situated adjacent to the sheet placing unit 30 and extending from the front side to the rear side of the multi-function product 10. The sidewall portions 32 support the scanner unit 40 only at rear sides thereof. The recess portion 30s extends from the cut portions 32a toward the discharge outlet 29. Accordingly, it is possible to see the sheet P placed on the sheet placing unit 30 from the sides of the multi-function product 10 in addition to the front side of the multi-function product 10, thereby making it easy to take out the sheet P and improving handling of the sheet P.

In the embodiments described above, the multi-function product 10 is explained as the image forming apparatus, and the present invention is applicable to a printer, a copier, a facsimile, and the likes.

The disclosure of Japanese Patent Application No. 2007-337481, filed on Dec. 27, 2007, is incorporated in the application by the reference.

While the invention has been explained with reference to the specific embodiments of the invention, the explanation is illustrative and the invention is limited only by the appended claims.

What is claimed is:

1. An image forming apparatus comprising:
a first image processing unit for performing a first image processing;
a discharge unit disposed above the first image processing unit for discharging a medium after the first image processing is performed on the medium;
a medium placing unit for placing the medium thus discharged;
a second image processing unit disposed above the medium placing unit for performing a second image processing;
an operational unit disposed on the second image processing unit at a specific position thereof for performing a specific operation; and
a step portion disposed in the medium placing unit for forming a space between the medium and the medium placing unit, said step portion and said operational unit being situated at positions so that the operational unit does not block a lower surface of the medium placing unit below the step portion viewed from above the image forming apparatus.

2. The image forming apparatus according to claim 1, wherein said second image processing unit includes a first side surface and a second side surface opposite to the first side surface, said step portion and said operational unit being situated on sides of the first side surface and the second side surface viewed from a front side of the image forming apparatus, respectively.

3. The image forming apparatus according to claim 2, wherein said step portion extends obliquely toward a center portion of the medium placing unit from a front side of the medium placing unit to a rear side of the medium placing unit.

4. The image forming apparatus according to claim 1, wherein said step portion is arranged so that a corner of the medium on the medium placing unit is situated over the step portion.

5. The image forming apparatus according to claim 1, further comprising a sidewall portion connecting the first image processing unit and the second image processing unit, said sidewall portion including a cut portion on a front side of the image processing apparatus.

6. The image forming apparatus according to claim 2, wherein said step portion is situated on one of the sides of the first side surface and the second side surface.

7. An image forming apparatus comprising:
an image forming unit for forming an image on a medium;
a discharge unit disposed above the image forming unit for discharging the medium after the image forming unit forms the image on the medium;
a medium placing unit for placing the medium thus discharged; and
a step portion disposed in the medium placing unit for forming a space between the medium and the medium placing unit, said step portion extending obliquely toward a center portion of the medium placing unit from a front side of the medium placing unit to a rear side of the medium placing unit.

8. The image forming apparatus according to claim 7, further comprising a recess portion for forming the step portion.

9. The image forming apparatus according to claim 7, further comprising a protruded portion for forming the step portion.

10. The image forming apparatus according to claim 7, wherein said step portion is arranged so that a corner of the medium on the medium placing unit is situated over the step portion.

11. An image forming apparatus comprising:
a first image processing unit for performing a first image processing;
a discharge unit disposed above the first image processing unit for discharging a medium after the first image processing is performed on the medium;
a medium placing unit for placing the medium thus discharged;
a second image processing unit disposed above the medium placing unit for performing a second image processing;
an operational unit disposed on the second image processing unit at a specific position thereof for performing a specific operation; and
a step portion disposed in the medium placing unit for forming a space between the medium and the medium placing unit, said step portion and said operational unit being situated at positions so that the operational unit does not block a space between the medium placing unit and the medium.

12. The image forming apparatus according to claim 11, wherein said second image processing unit includes a first side surface and a second side surface opposite to the first side surface, said step portion and said operational unit being situated on sides of the first side surface and the second side surface viewed from a front side of the image forming apparatus, respectively.

13. The image forming apparatus according to claim 12, wherein said step portion extends obliquely toward a center portion of the medium placing unit from a front side of the medium placing unit to a rear side of the medium placing unit.

14. The image forming apparatus according to claim 11, wherein said step portion is arranged so that a corner of the medium on the medium placing unit is situated over the step portion.

15. The image forming apparatus according to claim 11, further comprising a sidewall portion connecting the first image processing unit and the second image processing unit, said sidewall portion including a cut portion on a front side of the image processing apparatus.

16. The image forming apparatus according to claim 12, wherein said step portion is situated on one of the sides of the first side surface and the second side surface.
